(19) United States
(12) Patent Application Publication
(10) Pub. No.: US 2024/0242546 A1
(43) Pub. Date: Jul. 18, 2024

(54) CONTROL DEVICE AND CONTROL METHOD

(71) Applicant: TOYOTA JIDOSHA KABUSHIKI KAISHA, Toyota-shi (JP)

(72) Inventor: Shigeki NAGATA, Toyota-shi (JP)

(73) Assignee: TOYOTA JIDOSHA KABUSHIKI KAISHA, Toyota-shi (JP)

(21) Appl. No.: 18/485,571

(22) Filed: Oct. 12, 2023

(30) Foreign Application Priority Data
Jan. 17, 2023 (JP) 2023-005393

(51) Int. Cl. G07C 5/00; G07C 5/08

(52) U.S. Cl. CPC G07C 5/008; G07C 5/0841

(57) ABSTRACT

Upon receiving designation of data to be collected by the vehicle and designation of one or more parameters to be monitored among the plurality of types of parameters included in the data, the control device collects the data at predetermined time intervals, a control unit that sets a priority for deleting collected data, and lowers the priority for deleting data at the time when the value change is detected when a change is detected in the value of one or more parameters.

### CROSS-REFERENCE TO RELATED APPLICATION

This application claims priority to Japanese Patent Application No. 2023-005393 filed on Jan. 17, 2023, incorporated herein by reference in its entirety.

### BACKGROUND

### 1. Technical Field

The present disclosure relates to a control device and control method.

### 2. Description of Related Art

Conventionally, a technique for temporarily storing data collected by a vehicle is known. For example, Japanese Unexamined Patent Application Publication No. 2020-046971 (JP 2020-046971 A) discloses a system in which a server receives data collected by a vehicle. Further, Japanese Unexamined Patent Application Publication No. 2022-002040 (JP 2022-002040 A) discloses a concept of setting a priority for temporarily storing data to be transmitted from a vehicle to a collection center.

### SUMMARY

When a vehicle moves out of a communication range, the vehicle will not be able to transmit collected data to a server. In such a case, the vehicle temporarily stores the data that was not be able to be transmitted in a storage area. At this time, when the total amount of data to be stored reaches the upper limit of the physical capacity of the storage area, the vehicle deletes the data in order from the oldest data. However, there is an issue that important data in the old data is deleted.

Therefore, there is room for improvement in the technique for temporarily storing the data collected by the vehicle.

An object of the present disclosure made in view of such circumstances is to improve the technique for temporarily storing the data collected by the vehicle.

A control device according to an embodiment of the present disclosure is a control device for setting a priority of deleting data, and includes a control unit that collects, when designation of data to be collected by a vehicle and designation of one or more parameters to be monitored among a plurality of kinds of parameters included in the data are received, the data at a predetermined time interval, sets a priority of deleting the collected data, and lowers, when a change in a value of the one or more parameters is detected, the priority of deleting the data at a time when the change in the value is detected.

A control method according to an embodiment of the present disclosure is a control method executed by a control device for setting a priority of deleting data, and executes receiving designation of data collected by a vehicle and designation of one or more parameters to be monitored among a plurality of kinds of parameters included in the data;

collecting the data at a predetermined time interval; setting a priority of deleting the collected data; and lowering, when a change in a value of the one or more parameters is detected, the priority of deleting the data at a time when the change in the value is detected.

According to the embodiment of the present disclosure, the technique for temporarily storing the data collected by the vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a flowchart showing the operation of the control device;

FIG. 3 is a schematic diagram showing an example of priority settings for deleting temporarily stored data; and

FIG. 4 is a schematic diagram illustrating an example method for changing the priority of deleting data.

### DETAILED DESCRIPTION OF EMBODIMENTS

Hereinafter, an embodiment of the present disclosure will be described.

### Outline of Embodiment

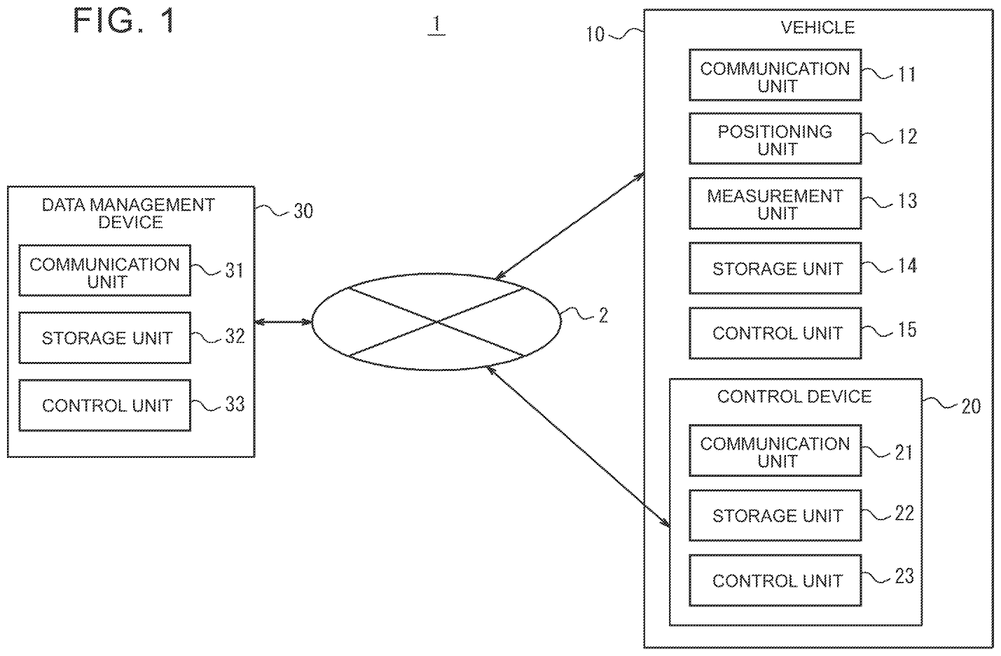

The outline of a system 1 according to an embodiment of the present disclosure will be described with reference to FIG. 1. A system 1 includes a vehicle 10, a control device 20 and a data management device 30. Vehicle 10 and control device 20 are communicably connected to data management device 30 via network 2 including, for example, the Internet and a mobile communication network.

The vehicle 10 is, for example, an automobile, but is not limited to this, and may be any vehicle. Automobiles include, but are not limited to, gasoline vehicles, Battery Electric Vehicles (BEV), Hybrid Electric Vehicles (HEV), Plug-in Hybrid Electric Vehicles (PHEV), Fuel Cell Electric Vehicles (FCEV), and the like. The number of vehicles 10 provided in the system 1 may be arbitrarily determined.

The control device 20 is, for example, a computer having a communication function. Control device 20 is provided in vehicle 10. The control device 20 is configured to communicate with the data management device 30 via the network 2.

The data management device 30 requests the control device 20 provided in the vehicle 10 to collect data, and receives the data collected by the vehicle 10 via the control device 20 and the network 2. The data management device 30 is, for example, a dedicated computer configured to function as a server, a general-purpose personal computer, a cloud computing system, or the like. The data management device 30 is configured to communicate with the control device 20 via the network 2. The data management device 30 may also be configured to be able to communicate with the vehicle 10 as well.

First, the outline of the present embodiment will be described, and the details will be described later. Control device 20 accepts designation of data collected by vehicle 10 and designation of one or more parameters to be monitored among a plurality of types of parameters included in the data. Then, the data for which the designation is accepted is collected at predetermined time intervals, and the priority for deleting the collected data is set. When a change is detected in the value of one or more parameters whose designation has been accepted, the priority of deleting data at the time when the change in value is detected is lowered.

As described above, according to the present embodiment, when a change in the value of a parameter to be monitored is detected, the priority of deleting data at the time when the value change is detected is lowered. Therefore, even if the total capacity of the temporarily stored data reaches the upper limit of the physical capacity of the storage area, the probability of deleting the data at the time when the change in value is detected is reduced. Thus, techniques for buffering vehicle-collected data are improved.

Next, each configuration of the system 1 will be described in detail.

### Configuration of Vehicle

As shown in FIG. 1, vehicle 10 includes communication unit 11, positioning unit 12, measurement unit 13, storage unit 14 and control unit 15.

Communication unit 11 includes one or more communication interfaces that connect to network 2. The communication interface corresponds to a communication standard such as 4th Generation (4G), 5th Generation (5G) or Controller Area Network (CAN), but is not limited to these. In this embodiment, the vehicle 10 communicates with the data management device 30 via the communication unit 11 and the network 2. Further, the communication unit 11 is communicably connected to the communication unit 21 of the control device 20 by wire or wirelessly.

The positioning unit 12 includes one or more receivers that acquire position information of the vehicle 10. Specifically, the positioning unit 12 includes, for example, a receiver compatible with GPS, but is not limited to this, and may include a receiver compatible with any satellite positioning system. Also, the acquired position information can be used for monitoring whether the vehicle 10 is stolen.

The measurement unit 13 includes one or more devices that monitor vehicle conditions such as the presence or absence of failures. Specifically, the one or more devices are pressure sensors, exhaust gas sensors, acceleration sensors, gyro sensors, millimeter wave radars, infrared radars, cameras, or the like. These devices measure and collect data inside and outside the vehicle 10.

The storage unit 14 includes one or more memories. The memory is, for example, a semiconductor memory, a magnetic memory, an optical memory, or the like, but is not limited to these. Each memory included in the storage unit 14 may function as, for example, a main storage device, an auxiliary storage device, or a cache memory. The storage unit 14 stores any information to be used for the operation of the vehicle 10. For example, the storage unit 14 may store system programs, application programs, embedded software, or the like. The information stored in the storage unit 14 may be updateable with information acquired from the network 2 via the communication unit 11, for example.

The control unit 15 includes one or more processors, one or more programmable circuits, one or more dedicated circuits, or a combination of these. The processor is, but not limited to, a general-purpose processor such as a Central Processing Unit (CPU) or a Graphics Processing Unit (GPU), or a dedicated processor specialized for specific processing. The programmable circuit is, for example, a Field-Programmable Gate Array (FPGA), but is not limited to this. The dedicated circuit is, for example, an Application Specific Integrated Circuit (ASIC), but is not limited to this. The control unit 15 controls the overall operation of the vehicle 10.

### Control Device Configuration

As shown in FIG. 1, the control device 20 includes a communication unit 21, a storage unit 22 and a control unit 23.

Communication unit 21 includes one or more communication interfaces that connect to network 2. The communication interface is compatible with communication standards such as 4th Generation (4G), 5th Generation (5G) or Controller Area Network (CAN), but is not limited to these and may be compatible with any communication standard. In this embodiment, the control device 20 communicates with the data management device 30 via the communication unit 21 and the network 2. Further, the communication unit 21 is communicably connected to the communication unit 11 of the vehicle 10 by wire or wirelessly.

The storage unit 22 includes one or more memories. Each memory included in the storage unit 22 may function as, for example, a main storage device, an auxiliary storage device, or a cache memory. The storage unit 22 stores any information used for the operation of the control device 20. For example, the storage unit 22 may store system programs, application programs, databases, data and parameters collected by the vehicle 10, and the like. The information stored in the storage unit 22 may be updateable with information acquired from the network 2 via the communication unit 21, for example.

The control unit 23 includes one or more processors, one or more programmable circuits, one or more dedicated circuits, or a combination of these. The control unit 23 controls the operation of the entire control device 20.

### Configuration of Data Management Device

As shown in FIG. 1, the data management device 30 includes a communication unit 31, a storage unit 32 and a control unit 33.

Communication unit 31 includes one or more communication interfaces that connect to network 2. The communication interface is compatible with communication standards such as 4th Generation (4G), 5th Generation (5G) or Controller Area Network (CAN), but is not limited to these and may be compatible with any communication standard. In this embodiment, the data management device 30 communicates with the vehicle 10 and the control device 20 via the communication unit 31 and the network 2.

The storage unit 32 includes one or more memories. Each memory included in the storage unit 32 may function as, for example, a main storage device, an auxiliary storage device, or a cache memory. The storage unit 32 stores arbitrary information used for the operation of the data management device 30. For example, the storage unit 22 may store system programs, application programs, databases, data and parameters received from the control device 20, and the like. The information stored in the storage unit 32 may be updateable with information acquired from the network 2 via the communication unit 31, for example.

The control unit 33 includes one or more processors, one or more programmable circuits, one or more dedicated circuits, or a combination of these. The control unit 33 controls the operation of the data management device 30 as a whole.

### Control Device Operation Flow

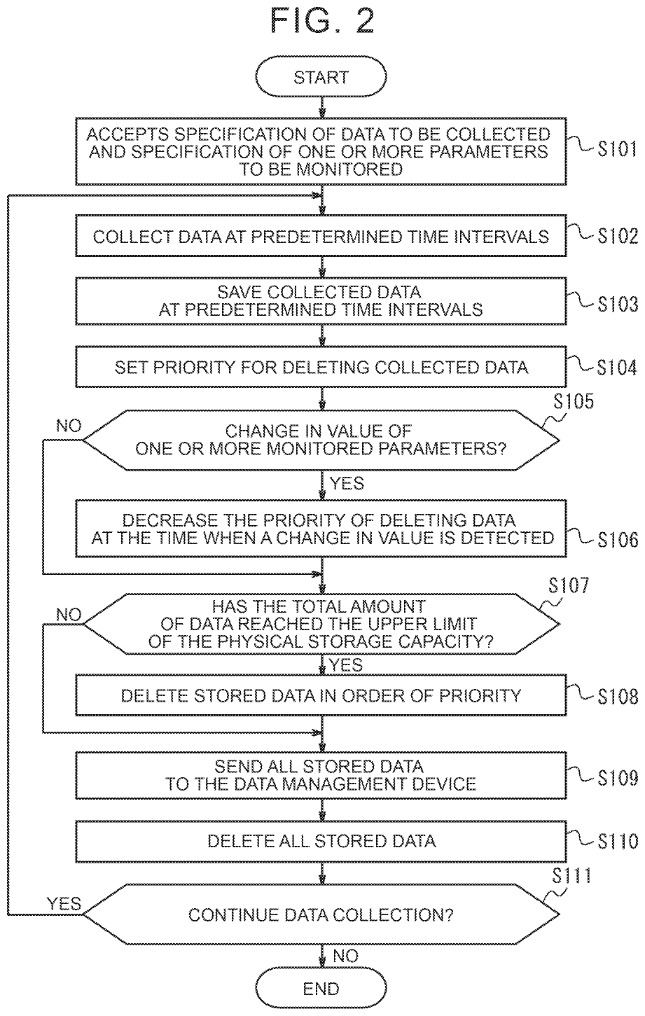

The operation of the control device 20 according to this embodiment will be described with reference to FIG. 2. This operation relates to setting the priority of deleting data.

S101: The communication unit 21 accepts designation of data collected by the vehicle 10 and designation of one or more parameters to be monitored among a plurality of types of parameters included in the data.

Vehicle 10 can collect various data (e.g., CAN data). The data collected by vehicle 10 includes multiple types of parameters. Also, the types and number of parameters included differ depending on the data. In this embodiment, an example will be described in which data including five types of parameters indicating time, location, failure, speed, and theft are designated as objects to be collected, and a parameter indicating the failure and a parameter indicating the theft among the five types of the parameters are designated as the parameter to be monitored. However, the data designated as collection targets and the parameters designated as monitoring targets are not limited to this example. For example, an operator or vehicle user may be able to arbitrarily specify parameters.

The data management device 30 designates data collected by the vehicle 10, including multiple types of parameters. Further, the data management device 30 designates one or more parameters to be monitored among the plurality of types of parameters, and requests the control device 20 to collect data. The communication unit 21 receives the designation from the data management device 30 and transmits the designation to the control unit 23. In order to identify one or more parameters to be monitored, the control unit 23 may assign a set value for identification to, for example, a parameter indicating the presence or absence of a failure or a parameter indicating the presence or absence of theft.

S102: The control unit 23 collects the data specified in S101 at predetermined time intervals.

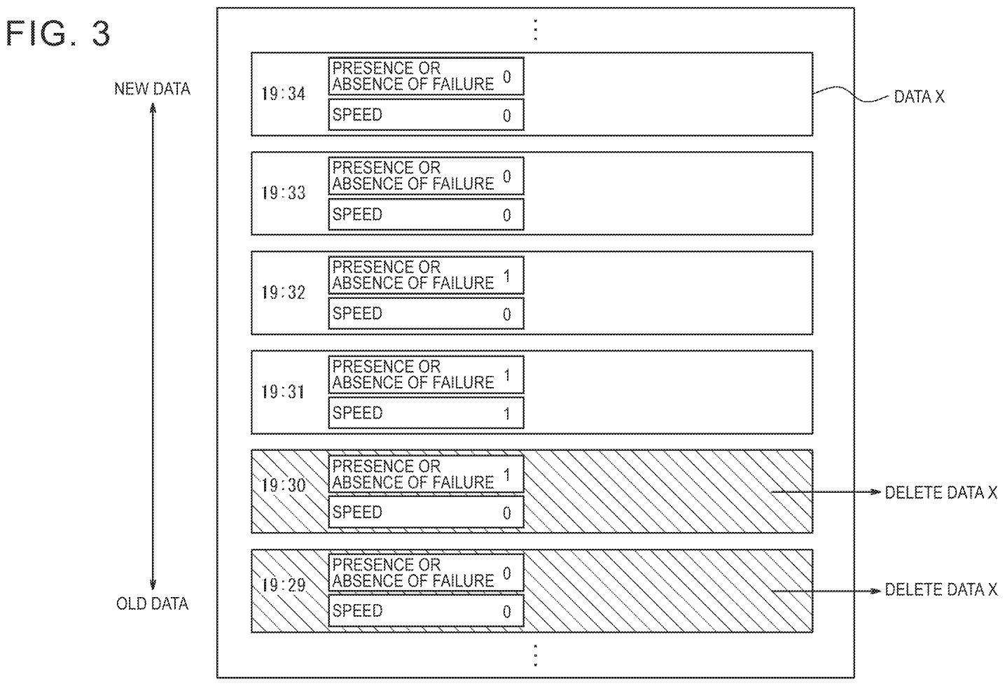

Control unit 23 causes vehicle 10 to collect data including multiple types of parameters at predetermined time intervals, and receives the collected data from vehicle 10. FIG. 3 is a schematic diagram showing an example of setting priorities for deleting temporarily stored data. In the example of FIG. 3, the vehicle 10 collects data X including parameters indicating the presence or absence of failures and speed corresponding to multiple types of parameters at intervals of one minute, and transmits the data to the control device 20.

The control unit 15 of the vehicle 10 causes the positioning unit 12 having a receiver corresponding to GPS to measure parameters such as the position or the presence or absence of theft, and measures the presence or absence of failure, speed, etc. by the measurement unit 13 having various sensors, collects data including one or more measured parameters, and transmits the data to the communication unit 21 of the control device 20.

S103: The storage unit 22 saves the collected data in the storage area at predetermined time intervals.

The storage unit 22 of the control device 20 temporarily stores the data collected by the vehicle 10 in the format shown in FIG. 3, for example.

S104: The control unit 23 sets the priority of deleting the collected data.

In the example of FIG. 3, data X including parameters indicating the presence or absence of failure and speed is measured at intervals of one minute from 19:30 to 19:34. In this S104, the “priority for deletion” of data X is set higher for older data and lower for newer data. However, if this is left as it is, if the data at 19:29 and 19:30 (old data) are important data, there will be a problem that the important data will be deleted.

S105 to S106: When a change in the value of one or more parameters to be monitored is detected, the control unit 23 lowers the priority of deleting the data at the time when the value change is detected.

As described above, the data collected by the vehicle 10 includes, for example, five types of parameters indicating “time”, “position”, “failure”, “speed”, and “theft”. It is assumed that “presence/absence of failure” is a parameter to be monitored. The control unit 23 monitors changes in the value of the monitoring target parameter. As described above, the parameter to be monitored may be given a set value for identification. For example, the control unit 23 sets a flag of “0” when the data collected from the vehicle 10 is normal, and sets a flag of “1” when an abnormal value indicating a failure is detected. Here, for example, it is assumed that the value of the parameter changes from 0→0→0→1→1. Then, the data of the time when the value changes at the timing when the value before and after changes (changes from 0 to 1 or from 1 to 0) is determined to be important data for investigating the cause of the data change. As a result, the “deletion priority” of the data at the time when the value changes is lowered.

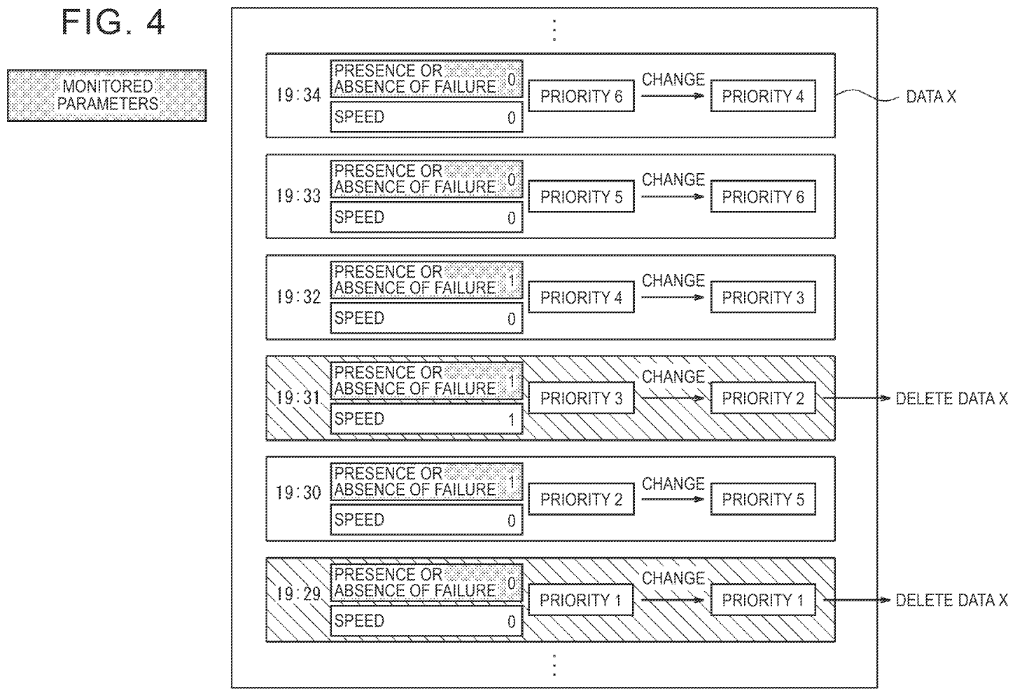

FIG. 4 is a schematic diagram illustrating an example method for changing the priority of deleting data. In FIG. 4, it is assumed that a parameter indicating “presence/absence of failure” is designated as a parameter to be monitored. In FIG. 4, it is assumed that the smaller the numerical value added after “Priority”, the higher the priority of data deletion. For example, priority 1 is the highest priority for deleting data. Priority 6 has the lowest priority for deleting data. As shown in FIG. 4, the value of the parameter indicating “presence/absence of failure” changes from 0 to 1 at 19:30 and from 1 to 0 at 19:33. Therefore, the “priority for deletion” of data X at 19:30 is lowered from priority 2 to 5, and the “priority to delete” for data X at 19:33 is lowered from priority 5 to 6.

By lowering the “deletion priority” of the data X at the time when the value changes, the probability of maintaining the data at the time when the value changes is improved. As a result, it becomes possible to investigate the cause why the device, which has been out of order for a long time, has returned to normal (1→1→1→1→0). A parameter indicating “speed” that is not specified as a monitoring target is ignored even if the value changes (the “priority for deletion” is not lowered).

S107 to S108: When the total amount of data temporarily stored in the storage area of the storage unit 22 reaches the upper limit of the physical capacity of the storage area, the control unit 23 deletes the data in descending order of priority.

As shown in FIGS. 3 and 4, if the storage area of the storage unit 22 has a physical capacity for storing only four pieces of data X, two pieces of data X must be deleted. In the example shown in FIG. 3, data X at 19:29 and 19:30 are deleted regardless of the importance of the data. On the other hand, as shown in FIG. 4, if the priority of deleting data is changed, the probability that the data at 19:30 and 19:33 with changed values will be maintained increases.

S109: When the control unit 23 enters a communication range with the data management device 30, it transmits all the data temporarily stored in the storage area to the data management device 30 via the communication unit 21 and the network 2.

The data management device 30 receives data collected by the vehicle 10 requested from the control device 20 via the communication unit 21 of the control device 20 and the network 2. The control unit 33 of the data management device 30 saves the received data in the storage unit 32 and uses it for investigating the cause of the failure.

S110: The control unit 23 deletes all of the transmitted data from the storage area of the storage unit 22.

After transmitting the temporarily stored data to the data management device 30, the control unit 23 empties the storage area of the storage unit 22 and secures a physical capacity for temporarily storing the data collected by the vehicle 10 again.

S111: The control unit 23 determines whether to continue data collection. If data collection is to be continued, the process returns to S102, and if data collection is to end, the process ends.

As described above, the control device 20 according to the present embodiment accepts designation of data collected by the vehicle 10, and designation of one or more parameters to be monitored among a plurality of types of parameters included in the data. Then, the control device 20 collects the data for which the designation has been received at predetermined time intervals, and sets the priority for deleting the collected data. When the control device 20 detects that there is a change in the value of one or more parameters whose designation has been accepted, the control device 20 lowers the priority of deleting data at the time when the change in value is detected.

According to such a configuration, when a change is detected in the value of the parameter to be monitored, the priority of deleting the data at the time when the change was detected is lowered. Therefore, even if the total capacity of the temporarily stored data reaches the upper limit of the physical capacity of the storage area, the probability of deleting the data at the time when the change in value is detected is reduced. Thus, techniques for buffering vehicle-collected data are improved.

Although the present disclosure has been described with reference to figures and examples, a person skilled in the art may make various modifications and alterations based on the present disclosure. Accordingly, these variations and modifications are included within the scope of this disclosure. For example, functions included in each component or each step can be rearranged so as not to be logically inconsistent. Also, multiple components, steps, etc. may be combined into one or divided.

For example, in the above-described embodiment, an embodiment is also possible in which the configuration and operation of the control device 20 are distributed among a plurality of computers that can communicate with each other. Further, for example, an embodiment in which some or all of the components of the control device 20 are provided in the vehicle 10 is also possible. For example, the communication unit 11, the storage unit 14, the control unit 15 and the like provided in the vehicle 10 may include some or all of the components of the control device 20. For example, when the communication unit 11 of the vehicle 10 has the function of the communication unit 21 of the control device 20, the communication unit 11 of the vehicle 10 designates data collected from the data management device 30 and monitors one or more data to be monitored, and may transmit the collected data to the control device 20.

In the above-described embodiment, for example, the data management device 30 selects the data to be collected and the predetermined parameters to be monitored based on the results of responses to a questionnaire by an automobile manufacturer, for example, when a user who feels that the operation of his or her vehicle is malfunctioning, may be configured as specified. According to such a configuration, the data management device 30 analyzes the cause of the malfunction of the vehicle 10. The user can acquire the cause analysis result of the malfunction of the vehicle 10 from the data management device 30 and take necessary measures such as repair.

Also, an embodiment is possible in which, for example, a general-purpose computer functions as the control device 20 according to the above-described embodiment. Specifically, a program describing processing details for realizing each function of the control device 20 according to the above-described embodiment is stored in the memory of a general-purpose computer, and the program is read and executed by the processor. Therefore, the present disclosure can also be realized as a program that can be executed by the processor or a non-transitory computer-readable medium that stores the program.

What is claimed is:

1. A control device for setting a priority of deleting data, the control device comprising a control unit that collects, when designation of data to be collected by a vehicle and designation of one or more parameters to be monitored among a plurality of kinds of parameters included in the data are received, the data at a predetermined time interval, sets a priority of deleting the collected data, and lowers, when a change in a value of the one or more parameters is detected, the priority of deleting the data at a time when the change in the value is detected.

2. The control device according to claim 1, wherein the kinds of parameters included in the data include five kinds of parameters each indicating a time, a location, presence or absence of failure, a speed, and presence or absence of theft, and a parameter indicating the presence or absence of the failure or a parameter indicating the presence or absence of the theft is designated as the parameter to be monitored.

3. The control device according to claim 1, wherein:
the control device further includes a storage unit including a storage area for storing the collected data at the predetermined time interval; and
the control unit deletes the data in descending order of the priority when a total capacity of the stored data reaches an upper limit of a physical capacity of the storage area.

4. The control device according to claim 3, wherein the control unit transmits, when entering a communication range in which the control unit is able to communicate with a data management device, all of the data stored in the storage area to the data management device, and deletes all of the transmitted data from the storage area.

5. A control method executed by a control device for setting a priority of deleting data, the control method executing:
receiving designation of data collected by a vehicle and designation of one or more parameters to be monitored among a plurality of kinds of parameters included in the data;
collecting the data at a predetermined time interval;
setting a priority of deleting the collected data; and
lowering, when a change in a value of the one or more parameters is detected, the priority of deleting the data at a time when the change in the value is detected.
